(19) United States
(12) Patent Application Publication
(10) Pub. No.: US 2005/0201775 A1
(43) Pub. Date: Sep. 15, 2005

(54) Method for removing toner on an image-bearing member

(75) Inventor: Yuichi Ikeda, Abiko-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/075,812

(22) Filed: Mar. 10, 2005

(30) Foreign Application Priority Data
Mar. 12, 2004 (JP) 2004-070256

(51) Int. Cl. G03G 15/16

(52) U.S. Cl. 399/101; 399/297

(57) ABSTRACT

The present invention relates to an image forming device comprises: an image bearing member; a transfer means; a first removing means which is provided outside transfer area and removes the toners on the image bearing member; and a second removing means which is provided outside transfer area and removes the toners on the transfer means. The toner image in the transfer area is transferred onto the transfer means by applying a bias with an opposite polarity with that of the predetermined polarity to the transfer means when the toner image formed according to the image information is in the transfer area, and no transfer material exists in the transfer area, and, at this time, and the toner image transferred onto the transfer means is removed with the second removing means, while the toners which have not been transferred onto the transfer material and have remained on the image bearing member is removed with the first removing means.

### BACKGROUND OF THE INVENTION

1. Field of the Invention

The present invention relates to a method for removing toner on an image bearing member in an image forming device which is provided with the image bearing member bearing a toner image, and forms the toner image on a transfer material according to an electrophotographic method.

2. Related Background Art

Recently, it has been required even in an image forming device using the electrophotographic method that a high-quality image is realized and toner on an image bearing member is securedly removed.

A method, by which a blade element as a removing means is contacted with an intermediate transfer member as an image bearing member to remove a toner image, has been disclosed in Japanese Patent Laid-Open Publication No. 2001-228752 as a method for removing a toner image on an image bearing member.

However, for example, when jamming is generated, or when a toner image formed on the image bearing member is a patch image for density control, there has been caused a problem that a part of the toners of the toner image can not be removed by the removing means, when the toner image formed on the image bearing member according to image information is carried to the removing means without transferring the image on the transfer material.

### SUMMARY OF THE INVENTION

Accordingly, the object of the present invention is to provide an image forming device by which toner can be appropriately removed when a toner image formed on an image bearing member according to image information is carried to a removing means, by which toner on the image bearing member is removed, without transferring the toner image on a transfer material.

Another object of the present invention is to provide an image forming device comprising:
an image bearing member which bears a toner image formed of toners that have been charged to the predetermined polarity according to image information;
a transfer means by which the toner image on the image bearing member is transferred onto a transfer material by applying a bias with an opposite polarity with that of the predetermined polarity to the transfer material in a transfer area;
a first removing means which is provided outside the transfer area and removes the toners on the image bearing member; and
a second removing means which is provided outside the transfer area and removes the toners on the transfer means,
wherein the toner image in the transfer area is transferred onto the transfer means by applying a bias with an opposite polarity with that of the predetermined polarity to the transfer means when the toner image formed according to the image information is in the transfer area, and no transfer material exists in the transfer area, and, at this time, the toner image transferred onto the transfer means is removed with the second removing means, while the toners which have not been transferred onto the transfer material and have remained on the image bearing member is removed with the first removing means.

### BRIEF DESCRIPTION OF THE DRAWINGS

FIG. 1 is an explanatory view of an image forming device according to an embodiment 1;

FIG. 2 is an explanatory view of an image forming section according to an embodiment 2;

FIG. 3 is an explanatory view of an image forming device according to the embodiment 2;

FIG. 4 is an explanatory view of a cleaning processing for a patch on an intermediate transfer belt;

FIG. 5 is an explanatory view of a reference example according to the embodiment 2;

FIG. 6 is an explanatory view of an image forming device according to an embodiment 3;

FIG. 7 is an explanatory view showing a position of a density detection means in the image forming device according to the embodiment 3; and

FIG. 8 is an explanatory view showing the details of the intermediate transfer belt 28.

### DETAILED DESCRIPTION OF THE PREFERRED EMBODIMENTS

In the present invention, when a toner image formed according to image information is not transferred onto a transfer material, the toner image on an image bearing member is transferred onto a transfer means by which the toner image on the image bearing member is transferred onto the transfer material. Then, the toner image transferred to the transfer means is removed by a removing means by which toners on the transfer means is removed. Moreover, when the toner image is transferred from the image bearing member to the transfer member, toners remaining on the image bearing member are removed by another removing means by which toners on the transfer means are removed.

Thereby, the toners of the toner image not transferred to the transfer material are divided into those on the image bearing member and into those on the transfer means. Accordingly, the mass per unit area of the toners which should be removed by the removing means to remove toners on the image bearing member is reduced. As described above, the above-described problem that a part of the toners of a toner image can not be removed has been able to be solved.

Hereinafter, embodiments according to the present invention will be explained in detail.

Embodiments according to the present invention will be explained with reference to the drawings.

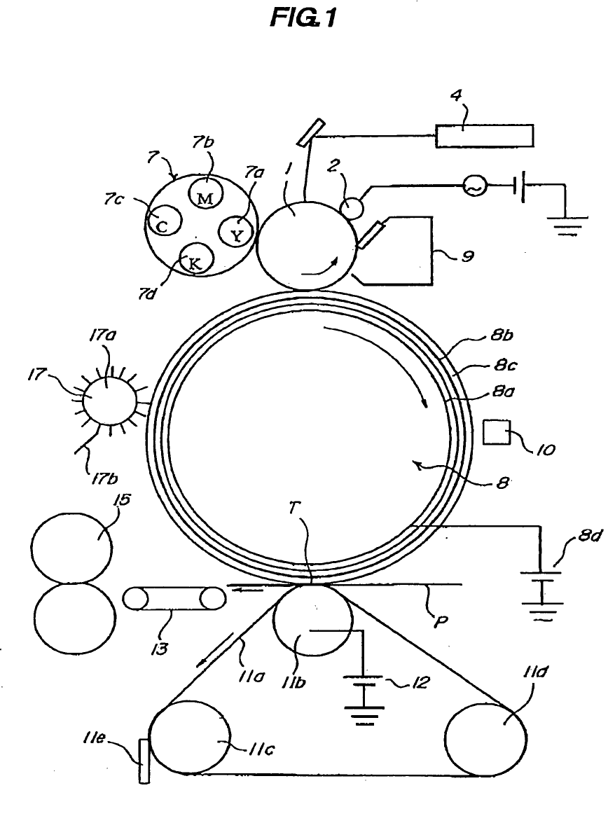

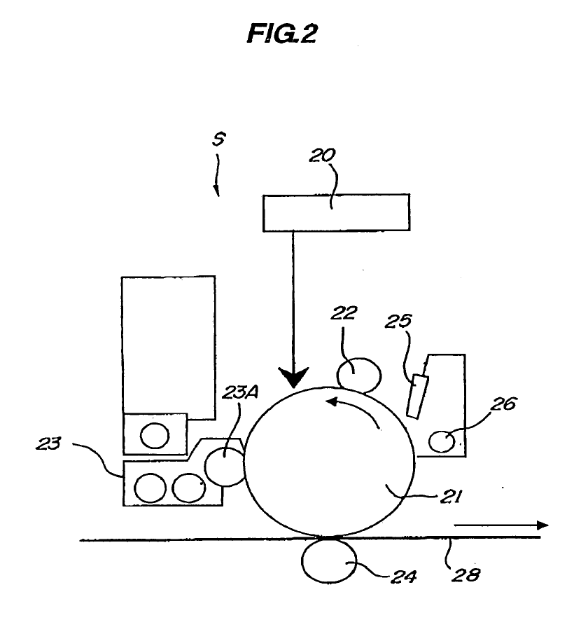

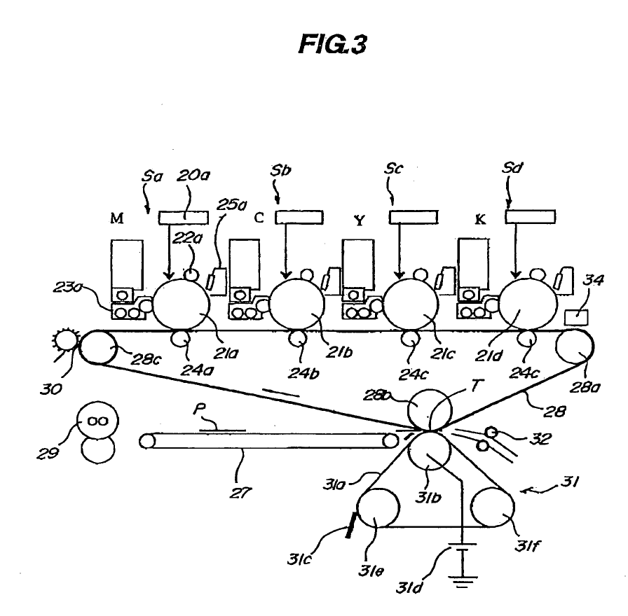

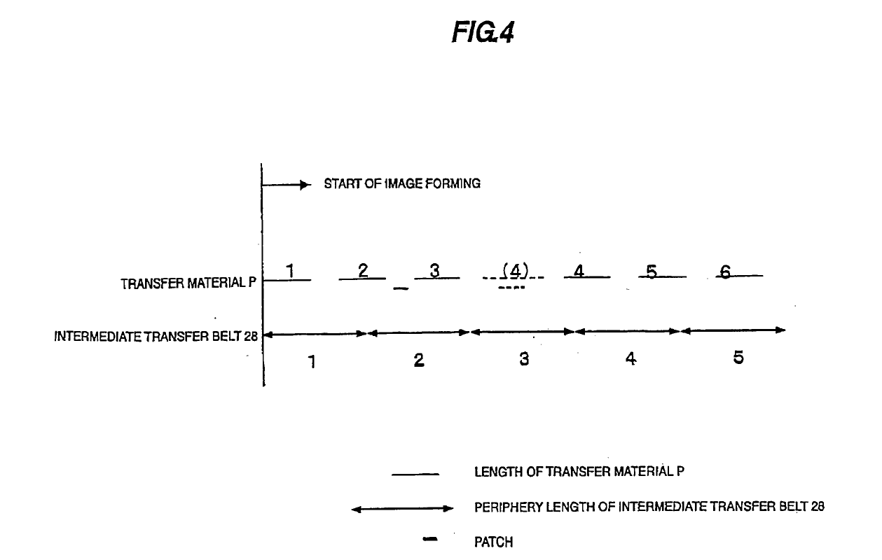

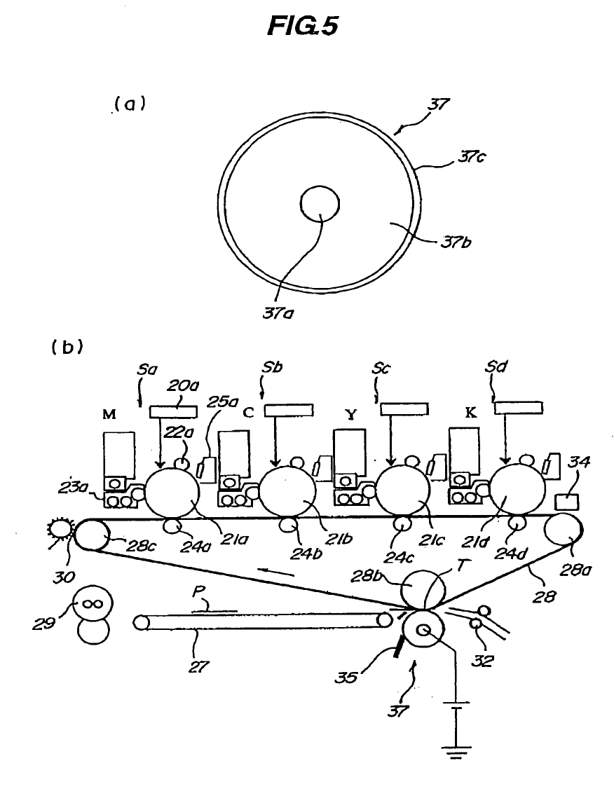

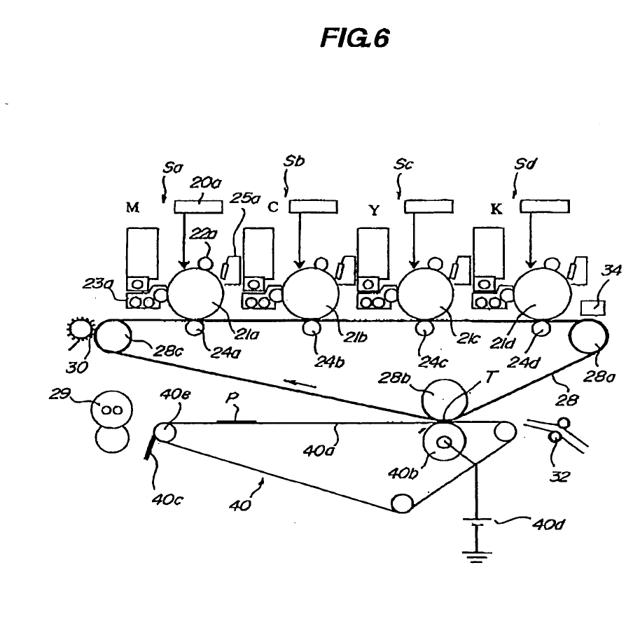

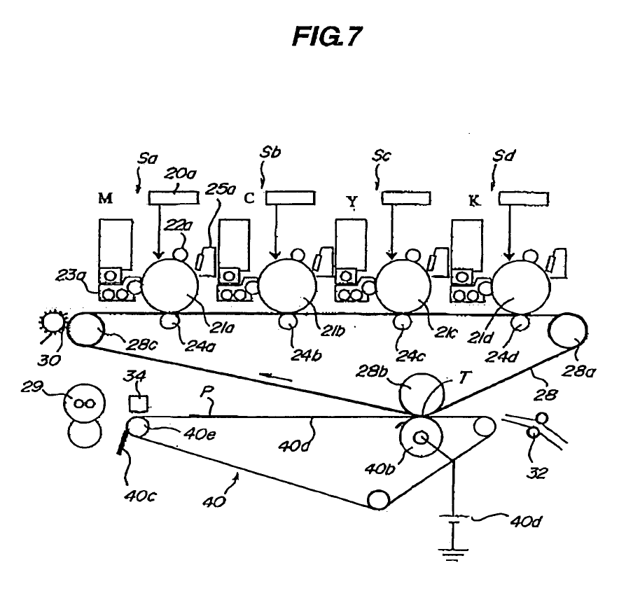

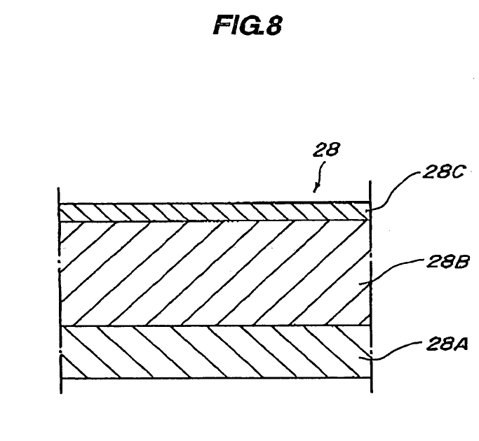

FIG. 1 is an explanatory view of an image forming device according to an embodiment 1; FIG. 2 is an explanatory view of an image forming section according to an embodiment 2; FIG. 3 is an explanatory view of an image forming device according to the embodiment 2; FIG. 4 is an explanatory view of a cleaning processing for a patch on an intermediate transfer belt; FIG. 5 is an explanatory view of a reference example according to the embodiment 2; FIG. 6 is an explanatory view of an image forming device according to an embodiment 3; FIG. 7 is an explanatory view showing a position of a density detection means in the image forming device according to the embodiment 3; and FIG. 8 is an explanatory view showing the details of the intermediate transfer belt.

### Embodiment 1

(Configuration and Operation for Image Forming)

An embodiment 1 according to the invention will be explained. In the image forming device according to the present embodiment, an image is formed on a transfer material P through steps: a toner-image forming step at which a toner image is formed on a photosensitive drum 1; a primary transfer step at which toner images formed on the photosensitive drum 1 are transferred onto an intermediate transfer member 8 one by one; a secondary transfer step at which colored toner images formed on the intermediate transfer member 8 are transferred onto a transfer material P; and a fixing step at which colored toner images transferred on the transfer material P. Then, the details of the steps will be explained.

In the first place, the image forming device according to the embodiment 1 comprises the photosensitive drum 1 as shown in FIG. 1. There are provided around the photosensitive drum 1: a primary charger (charging roller 2) by which a bias is applied to a periphery of the photosensitive drum 1 for charging the photosensitive drum 1 uniformly; an exposure means 4 by which electrostatic latent images for making toner images are formed by exposing the photosensitive drum 1 uniformly charged; a development means 7 (a yellow development unit 7a, a magenta development unit 7b, a cyan development unit 7c, and a black development unit 7d) by which the toner images are formed by supplying toners or the like to the electrostatic latent images; and a cleaning means 9 by which toners remaining on the photosensitive drum 1 are cleaned off the drum 1 after the primary transfer step.

At the toner image forming step, the photosensitive drum 1 rotates counterclockwise as shown in the drawing. The surface of the photosensitive drum 1, wherein the drum 1 has passed a position at which the drum 1 is in opposition to the charging roller 2, is uniformly charged to a predetermined potential and polarity. Then, exposing of, for example, laser beams from the exposure means 4 is executed according to image information transmitted to the device to form an electrostatic latent image on the photosensitive drum 1. At this point, toners that have been charged to the predetermined polarity are supplied from a development unit for a first color (for example, the yellow development unit) to the formed electrostatic latent image.

Thus, a toner image for the first color is formed on the photosensitive drum 1. At this time, development units for second through fourth colors (the magenta development unit 7b, the cyan development unit 7c, and the black development unit 7d) are not operated. Accordingly, the photosensitive drum 1 is not acted upon by the development units for second through fourth colors, and the toner image of yellow as the first color is not influenced by the development units 7b through 7d. Moreover, the toner image formed on the photosensitive drum 1 is transferred onto the later-described intermediate transfer member 8, and the cleaning means 9 cleans toners off the drum 1, wherein the toners have remained on the photosensitive drum 1.

In the downstream side from the development units in the photosensitive drum 1, the intermediate transfer member (image bearing member) 8 is arranged in opposition to the photosensitive drum 1. The intermediate transfer member 8 is an elastic roller with a medium resistance, wherein the roller comprises an elastic layer 8b on the surface of the outer periphery of pipe-like cored metal 8a, and a surface layer 8c is formed on the outer periphery of the elastic layer 8b. The elastic layer 8b is made of NBR (nitrile-butadiene rubber)/epichlorohydrin rubber, wherein the thickness is 5 mm, the rubber hardness is JIS-A 35 degrees through 41 degrees (1 kgf loading), and the resistance is 6e5 Ωcm through 3e6 Ωcm.

The surface layer 8c is made of urethane resin, wherein the thickness is 20 μm, and the resistance is 3e12 Ωcm through 8e13 Ωcm.

The measured hardness is about 2 N/mm₂ through 3 N/mm₂ in universal hardness (hardness tester: Fischer hardness tester with a Vickers pyramid-type indenter, maximum load: 1 mN, and loading time: 0.2 sec). Moreover, a primary bias power supply 8d is added to charge the intermediate transfer member 8 to a predetermined voltage.

At the primary transfer step, the intermediate transfer member 8 rotates clockwise, as shown in the drawing, at the same peripheral velocity as that of the photosensitive drum 1. An electric field is formed on the surface of the intermediate transfer member 8 by a transfer bias (primary transfer bias) applied from the primary power supply 8d. This primary transfer bias applied by the primary power supply 8d is, for example, +110 V through +3000 V with an opposite polarity (+) to that of toners. The toner image of yellow as the first color is attracted by this electric field onto the intermediate transfer member 8 for primary transfer wherein the toner image has been formed on the photosensitive drum 1.

As described above, the toner image of yellow as the first color is transferred onto the intermediate transfer member 8, and, similarly, a toner image of magenta as the second color, a toner image of cyan as the third color, and a toner image of black as the fourth color are also transferred onto the intermediate transfer member 8 one by one. Thereby, a colored toner image which is formed as a target image according to image information is formed on the intermediate transfer member 8.

A secondary transfer unit 11 is arranged under the intermediate transfer member 8. The secondary transfer unit 11 comprises: a secondary transfer belt 11a as an endless belt member; a secondary transfer roller 11b which has an axis in parallel with that of the intermediate transfer member 8 and is in opposition to the intermediate transfer member 8 through the secondary transfer belt 11a; and a secondary bias power supply 12 to charge the secondary transfer roller 11b. The secondary transfer unit 11 will be explained in detail later.

At the secondary transfer step, the secondary transfer belt 11a is moved counterclockwise, as shown in the drawing, at the same peripheral velocity as that of the intermediate transfer member 8. Moreover, the transfer material P such as paper is carried from a not-shown feeding means to a part (nip section) at which the intermediate transfer member 8 and the secondary transfer roller 11b are opposing to each other. A secondary transfer bias with an opposite polarity with that of the charged polarity for the toners is applied with the secondary bias power supply 12 to the secondary transfer roller 11b. Thereby, the colored toner image formed on the intermediate transfer member 8 is attracted to the side of the secondary transfer roller 11b by the electric field formed by the secondary transfer bias applied to the transfer roller 11b. Then, the colored toner image is transferred onto the transfer material P passing the nip section. A secondary transfer bias are applied to the secondary transfer roller 11a through the secondary transfer roller 11b. At this time, the toner image on the intermediate transfer member 8 is transferred onto the transfer material P located in a transfer area T on the secondary transfer belt 11a when the toner image is carried to the transfer area T on the intermediate transfer member 8.

A transport means 13 by which the transfer material P is carried, and a fixing device 15 by which the toner image is fixed by pressurization and heating of the transfer material P carried from the transport means 13 are provided at the downstream side, in the transport direction of the transfer material P, from the above-described nip section.

At the fixing step, the transfer material P carried with the transport means 13 is supported with a plurality of rollers disposed in the fixing device 15, and is pressurized and heated for secondary transfer of the colored toner image. Thereby, the colored toner image is fixed on the transfer material P, and a series of operations for image forming are completed.

(Configuration and Operation for Cleaning)

In the intermediate transfer member 8, a cleaning means 17 (a first removing means) is provided at the downstream side, in the rotating direction, from the above-described nip section, wherein remaining toners, which have been not used for transferring at secondary transfer and have remained on the intermediate transfer member 8, are cleaned off with the cleaning means 17. The cleaning means 17 includes: a fur brush 17a which is contacted with the surface of the intermediate transfer member 8; and a blade 17b which is contacted with the fur brush 17a and scratches toners adhered to the cleaning brush 17a thereoff. Moreover, the cleaning means 17 is configured in such a way that contact and non-contact can be made between the cleaning means 17 and the intermediate transfer member 8, and the non-contact is made during the primary transfer step.

Besides the toner image, a standard image (patch) as a standard for understanding the densities of the toner image is also transferred onto the intermediate transfer member 8. Thereby, a density detection means 10 which detects the densities of the patch is disposed in opposition to the intermediate transfer member 8. The density detection means 10 comprises LEDs (light emitting diodes) and a light receiving elements, and reads the reflected light amount of the patch formed on the intermediate transfer member 8 (patch detection). A control means of the image forming device calculates the amount of toners conveyed on the intermediate transfer member 8, based on the reflected light amounts, and decides image control conditions (for example, charging potentials and T/C ratio control) from the calculated result.

Cleaning processing for a patch according to prior arts will be explained, referring to the above-described configuration. Conventionally, the surface of an intermediate transfer member with an elastic layer has been damaged when a cleaning blade is contacted with the intermediate transfer member. Accordingly, cleaning has been executed with a fur brush in the case of an intermediate transfer member with an elastic layer. However, cleaning can not be completed at one time when a patch with a conveyed toner amount equal to or more than the amount of the remaining toners is formed, or when transportation is defective and a large amount of toners remain on an intermediate transfer member, though the secondary-transfer remaining toners (amount of conveyed toners: 0.2 mg/cm₂ or less), which have remained on the intermediate transfer member after secondary transfer, can be cleaned off at one time under the cleaning capacity of the fur brush. Accordingly, it is required to rotate the intermediate transfer member a plurality of times only for cleaning of the intermediate transfer member. The above requirements may cause increase in image forming time per unit sheet of paper and the worse productivity.

Accordingly, the present embodiment has adopted the secondary transfer unit 11 as a secondary transfer means by which secondary transfer of a toner image from the intermediate transfer member onto a transfer material is executed. As shown in FIG. 1, the secondary transfer unit 11 comprises: the endless secondary transfer belt (transfer means) 11a, by which the transfer material P is pressed against the intermediate transfer member 8 at a position at which the unit 11 and the intermediate transfer member 8 are opposing to each other; the secondary transfer roller 11b which is disposed in opposition to the intermediate transfer member 8 through the secondary transfer belt 11a and to which a high voltage (the secondary transfer bias) is applied from the secondarily bias power supply 12 to attract a toner image onto the transfer material P; and a cleaning blade 11e (a second removing means) which is contacted with the secondary transfer belt 11a. Moreover, the secondary transfer belt 11a is stretched by, for example, a driving roller 11c which drives the secondary transfer belt 11a for moving, and a tension roller 11d by which tension is applied to the secondary transfer belt 11a, as well as the secondary transfer roller 11b.

In the present embodiment 1, the secondary transfer belt 11a is made of a polyimide resin, wherein the volume resistance is 1e17 cm through 1e10 Ωcm, and the universal hardness is 60 N/mm₂ through 65 N/mm₂ (hardness tester: Fischer hardness tester with a Vickers pyramid-type indenter, maximum load: 1 mN, and loading time: 0.2 sec). Besides polyimide resin (PI), a resin with a comparatively high hardness such as poly-ethylene terephthalate (PET), and polyvinylidene fluoride (PVdF) can be used for the secondary transfer belt 11a. Thereby, the surface of the secondary transfer belt 11a is less damaged even by being applied with a cleaning blade 11e comprising nylon, urethane, or the like. Accordingly, a member with a blade shape, by which the applying pressure under which the member is contacted with the belt 11a can be raised, can be also used for cleaning without using the fur brush. Here, the hardness of the surface of the secondary transfer belt 11a, wherein the surface is in contact with the transfer material of the secondary transfer belt 11a, is higher than that of the surface onto which the toner image on the intermediate transfer member 8 is transferred.

According to such a configuration in the present embodiment, the patch formed on the intermediate transfer member 8 is attracted by working of a secondary transfer bias applied to the secondary transfer roller 11b for transfer of the patch onto the secondary transfer belt 11a, and the cleaning blade 11e cleans the patch off. As the hardness of the secondary transfer belt 11a is higher than that of the intermediate transfer member 8, the belt 11a is not easily damaged even when the cleaning blade 11e with a blade shape is contacted with the belt 11a and has less trouble, for example, rolling back. Accordingly, cleaning with the cleaning blade 11e can be realized. Moreover, the cleaning performance can be improved by raising the applying pressure under which the blade 11e is contacted with the belt 11a.

At this time, the mass per unit area of the patch (toner image) to be transferred onto the secondary transfer belt 11a is larger than that of the toners which have not been transferred onto the secondary transfer belt 11a and have remained on the image bearing member.

Moreover, the maximum mass per unit area of the toners which is on the secondary transfer belt 11a and can be cleaned off with the cleaning blade 11e is larger than the maximum mass per unit area of the toners which is on the intermediate transfer member 8 and can be cleaned off with the cleaning means 17.

On the other hand, there are obtained the same level of the amount of the remaining toners which have remained on the intermediate transfer member 8 after the patch and a large amount of remaining toners caused by defective transportation are completely transferred onto the secondary transfer belt 11a as that of toners which can be cleaned off even with the cleaning brush 17a as the cleaning means 17 at one time. Thereby, it is not required to rotate the intermediate transfer member a plurality of times only for cleaning of the intermediate transfer member. Then, the productivity is not reduced at cleaning of a part of toners which have remained on the intermediate transfer member at secondary transfer.

Moreover, the present embodiment has a configuration by which it is not required to apply a voltage with an opposite polarity to the secondary transfer roller 11b at cleaning in the secondary transfer unit 11, because a part of toners are configured to remain on the intermediate transfer member 8 for cleaning with the cleaning means 17. Thereby, voltage control of the secondary transfer roller 11b is simplified.

Though a case in which the patch formed on the intermediate transfer member 8 is removed from the intermediate transfer member 8 has been described in the above-described embodiment, the toner image on the intermediate transfer member 8 can be transferred onto the transfer belt 11a and can be removed with the cleaning blade 11e even when the transfer material S is not appropriately carried to the transfer area of the secondary transfer belt 11a and the transfer material S does not exist in the transfer area T when the toner image formed on the intermediate transfer member 8 is carried to the transfer area T, that is, the so-called jamming is generated. Moreover, the toners which have not been transferred onto the secondary transfer belt 11a and have remained on the intermediate transfer member 8 can be removed with the cleaning means 17 at this time.

### Embodiment 2

An embodiment 2 according to the present invention will be explained.

An image forming device according to the present embodiment is an in-line type image forming device in which image forming sections for a plurality of colors are separately arranged in series, and, while a transfer material is carried, images are superimposed one by one for image forming. The present invention is also effective for use in an in-line type image-forming device.

(Image Forming Section)

The image forming sections (process stations S) will be explained with reference to FIG. 2. Each of the image forming sections S for each color (magenta, cyan, yellow, and black) has the same configuration.

As shown in FIG. 2, the image forming section S includes a photosensitive drum 21 rotating counterclockwise as shown in the drawing. After the surface of the drum 21 is uniformly charged with a primary charger 22, an electrostatic latent image is formed on the surface of the photosensitive drum 21 by light exposure according to image information obtained with an exposure means 20 such as a LED and a laser beam. The electrostatic latent image becomes a toner image by supplying of toners with a development sleeve 23A which is included in a development means 23 and rotates counterclockwise in the drawing and by developing. The toner image is attracted by a first transfer means 24 in opposition to the photosensitive drum 21 through a intermediate transfer belt 28 for primary transfer onto the intermediate transfer belt 28.

On the other hand, toners (primary-transfer-remaining toners) which hare not been transferred onto the intermediate transfer belt 28 and have remained on the surface of the photosensitive drum 21 at primary transfer of the toner image are removed with a cleaning blade 25 contacting with the photosensitive drum 21. Moreover, the toners are carried to a not-shown waste toner container with a waste-toner transport screw 26. Then, the photosensitive drum 21 with the surface cleaned as described above is used for the subsequent image forming. Here, the process speed in the present embodiment is 100 mm/s.

(In-Line-Type Image Forming Device)

The in-line-type image forming device will be explained, using FIG. 3. FIG. 3 is a general view of the image forming device according to the embodiment 2.

As shown in FIG. 3, the in-line-type image forming device comprises the intermediate transfer belt 28 which has no ends and is moved counterclockwise as shown in the drawing. The intermediate transfer belt 28 is stretched for moving by rollers such as a driving roller 28a, a secondary-transport-section opposing roller 28b in opposition to a secondary-transport-section, and a stretching and suspending roller 28c. The intermediate transfer belt 28 is provided with an elastic layer.

The layer configuration of the intermediate transfer belt in this embodiment is shown in FIG. 8. A base layer 28A is made of a polyimide resin with dispersed carbon, wherein the thickness is 80 μm, and the volume resistance is 1e7 Ωcm-1e10 Ωcm. An elastic layer 28B is mainly made of rubber comprising CR, wherein the thickness is 300 μm, and the volume resistance is 1e7 Ωcm through 1e11 Ωcm. A surface layer 28C is made of fluoro rubber (FEM, and the thickness is 10 μm. The universal hardness using a Fischer hardness tester (with a Vickers pyramid-type indenter, maximum load: 1 mN, and loading time: 0.2 sec) is 3 N/mm₂ through 5 N/mm₂.

Besides the above-described configuration, the intermediate transfer belt may have another one including: a base material of an dielectric resin such as a polyimide, a polycarbonate, a polyethylene terephthalate, and a polyvinylidene fluoride; an elastic layer formed of an elastic material such as a polymer elastomer material such as an urethane and a polymer foam material; and a surface layer which is made of, for example, an acryl resin or a teflon to improve the peelability of toners.

The image forming sections Sa through Sd for four colors of magenta, cyan, yellow, and black are arranged on the above-described intermediate transfer belt 28. The toner image is formed on the photosensitive drums 21a through 21d. Here, the polarity of the toner image is a minus.

Moreover, a density detection means 34 is disposed in opposition to the intermediate transfer belt 28 and downstream from the image forming section Sd, which is one of the image forming sections in opposition to the intermediate transfer belt 28 and is in the lowermost reaches in the moving direction. The density detection means 34 comprising LEDs and light receiving elements reads the reflected light amount of a patch formed on the intermediate transfer belt 28. The amount of the toners conveyed on the intermediate transfer belt 28 is calculated, based on the reflected light amount of the patch, wherein the amount has been read, and image control conditions (charging potentials, T/C ratio control or the like) are decided from the calculated result.

At the secondary transfer step for an image, a transfer material P taken out of a not-shown feed cassette is carried to a secondary transfer section (the secondary-transport-section opposing roller 28b and the later-described secondary transfer unit 31 are opposing to each other at the secondary transfer section) on the intermediate transfer belt 28 through a regist roller 32.

At the secondary transfer step, the toners which have remained on the intermediate transfer belt 28 are cleaned off by collection with a fur brush 30. Even at this time, there is a limit in the cleaning capacity of the fur brush 30 in the same manner as that of the embodiment 1, and collection can not be completed at one time, depending on the amount of the secondary-transfer-remaining toners.

In order to form a patch between the transfer materials in the in-line-type image forming device, the intermediate transfer belt 28 is required to be moved a plurality of times until cleaning of the intermediate transfer belt 28 is completed, when a patch on the intermediate transfer belt 28 cannot be clean off with the fur brush 30 at one time. In the in-line-type image forming device, image forming can not be executed while the intermediate transfer belt 28 is moved a plurality of times. Accordingly, there is caused a problem that the productivity is reduced.

For example, it is assumed that a patch is made between the secondary transfer material P and the third one (at the second lap of moving of the intermediate transfer belt 28) when six images are continuously formed as shown in FIG. 4. At this time, primary transfer of a toner image to be transferred onto the fourth transfer material P (at the third lap of the intermediate transfer belt 28) cannot be realized because the patch is not completely cleaned off at one time. Thereby, a toner image to be transferred onto the fourth transfer material P is required after further cleaning to be transferred onto a place where a toner image to be transferred onto the fifth transfer material P is to be transferred. Accordingly, the productivity is reduced. Especially, when a patch is formed between transfer materials for density control every time, a speed at which a transfer material P is output after image forming is generally halved.

Furthermore, an image forming device shown in FIG. 5 may be considered as another embodiment. That is, a secondary transfer roller 37 (φ 24) has a configuration as shown in FIG. 5(a) in which a sponge layer 37b is provided with the outer layer of cored metal 37a, and a surface layer 37c of acrylic resin or the like is disposed as the outer layer of the sponge layer 37b, and the secondary transfer roller 37 is arranged in opposition to the above-described secondary-transport-section opposing roller 28b. Then, a cleaning blade 35 is contacted with the secondary transfer roller 37, as shown in FIG. 5(b), for cleaning. However, when the above-described secondary transfer roller 37 is used, a deformation of the sponge layer is caused, and the surface of the secondary transfer roller 37 easily becomes in a rough state with many rugged spots because the peripheral length of the roller is short. Accordingly, it may be considered that the above-described secondary transfer roller 37 is not suitable for cleaning with a blade.

Incidentally, the image forming device shown in FIG. 3 has adopted the second transfer units 31 as the secondary transfer means. The secondary transfer unit 31 comprises: an endless secondary transfer belt 31a by which the transfer material P is pressed against the intermediate transfer belt 28 at a position in opposition to the intermediate transfer belt 28; A secondary transfer roller 31b which is disposed in opposition to the intermediate transfer belt 28 through the secondary transfer belt 31a, and to which a high-voltage power supply to attract a toner image onto the transfer material P is applied from the secondary bias power supply 31d; and a cleaning blade 31c which is contacted with the secondary transfer belt 31a for cleaning. A secondary transfer bias is applied to the secondary transfer belt 31a through the secondary transfer roller 31b at secondary transfer. Moreover, the secondary transfer belt 31a is stretched by a driving roller 31e which drives the secondary transfer belt 31a for moving, a tension roller 31f which gives tension and the like to the secondary transfer belt 31a, as well as the secondary transfer roller 31b.

Here, the secondary transfer belt 31a (φ120) is made of an dielectric resin such as a polymide, a polycarbonate, a polyethylene terephthalate, and a polyvinylidene fluoride. Moreover, it is preferable that the hardness (measured in the universal hardness and the like) of the secondary transfer belt 31a is higher than that of the intermediate transfer belt 28.

The secondary transfer roller 31b comprises cored metal, and an elastic material such as rubber mixed with an electroconductive ionic substance such as sodium perchlorate, a polymer elastomer material such as an urethane, and a polymer foam material. Moreover, steady cleaning can be realized when the driving roller 31e in opposition to the cleaning blade 31c through the secondary transfer belt 31a is a hard roller of, for example, metal.

After the transfer material P onto which a toner image of four colors is transferred is separated from the intermediate transfer belt 28, the transfer material P is carried to a fixing device 29 with a transport belt 27. In the fixing device 29, the transfer material P is heated and pressurized with a pair of rollers, and the toner image is fixed onto the transfer material P.

In the present embodiment, a patch between the transfer materials, and a large amount of remaining toners caused by defective transportation are transferred from the intermediate transfer belt 28 onto the secondary transfer belt 31a which is easily cleaned off, and are cleaned off with a blade. Thereby, the patch and the remaining toners can be cleaned off at one time, and a state in which that a toner image cannot be transferred onto the intermediate transfer belt 28 as shown in FIG. 4 can be eliminated.

Moreover, the secondary transfer belt 31a has adopted a belt with φ120. Thereby, the belt 31a with a long service life can be realized because the peripheral length is longer in comparison with that of the secondary transfer roller 37 described as a reference example, and a polyimide material with a longer service life can be used as a belt material.

Thus, the productivity can be improved, and cleaning can be executed without damaging the intermediate transfer member by cleaning with the cleaning blade 31c which is contacted with the secondary transfer belt 31a after a patch formed on the intermediate transfer belt 28 with an elastic layer and secondary-transfer-remaining toners thereon have been transferred onto the secondary transfer belt 31a.

### Embodiment 3

An embodiment 3 according to the present invention will be explained with reference to FIG. 6.

An image forming device according to the present embodiment is characterized in that the secondary transfer belt 31a in the secondary transfer unit 31 according to the embodiment 2 is also used as a transport belt after secondary transfer. The steps before the step at which a toner image is formed on an intermediate transfer belt 28 are the same as those of the embodiment 2.

As shown in FIG. 6, a secondary transfer unit 40 as a secondary transfer means in the present embodiment comprises: an endless secondary transfer transport belt 40a and carries a transfer material P before and after secondary transfer in a secondary transfer section; a secondary transfer roller 40b which is disposed in opposition to the intermediate transfer belt 28 through the secondary transfer transport belt 40a and to which a high-voltage power supply to attract a toner image onto the transfer material P is applied from a secondary bias power supply 40d; and a cleaning blade 40c which is contacted with the secondary transfer transport belt 40a for cleaning. Moreover, the secondary transfer belt 40a is stretched by a driving roller 40e which drives the secondary transfer belt 40a for moving, and a plurality of other rollers, as well as the secondary transfer roller 40b. A secondary transfer bias is applied to the secondary transfer transport belt 40a through the secondary transfer roller 40b at secondary transfer.

According to this configuration, the transfer material P passing through a regist roller 32 is carried to the secondary transfer transport belt 40a under attraction, and is carried to the secondary transfer section in which a secondary-transport-section opposing roller 28b and the secondary transfer roller 40b are opposing to each other. At this time, the toner image on the intermediate transfer member 8 is attracted by working of the secondary transfer roller 40b to which a high voltage is applied from the secondary bias power supply 40d, and secondary transfer of the above-described toner image onto the transfer material P is executed in the secondary transfer section. Subsequently, the transfer material P is carried in the direction to a fixing device 29 while the transfer material P is left attracted on the secondary transfer transport belt 40a, and the material P is carried into the fixing device 29. The transfer material P is pressurized and heated, and the toner image is fixed in the fixing device 29. Moreover, a method by which a patch and secondary-transfer-remaining toners are cleaned off with the cleaning blade 40c after the patch and the secondary-transfer-remaining toners have been transferred onto the secondary transfer transport belt 40a is similar to that of the embodiment 2.

As described above, the secondary transfer transport belt 40a is used before and after the secondary transfer section for a transport belt which carries the transfer material P in the present embodiment. Thereby, separation in the secondary transfer section can be stably executed by secondary transfer under a state in which the transfer materials P is left attracted to the secondary transfer transport belt 40a Moreover, the configuration is made simple by integration of the transport belt and the secondary transfer unit into one piece. Furthermore, further longer service life of the secondary transfer transport belt 40a can be realized because the peripheral length of the secondary transfer transport belt 40a is increased to that corresponding to φ300 by common use of the secondary transfer belt as the transport belt transporting the transfer material P.

Here, a density detection means 34 may be arranged in opposition not to the intermediate transfer belt 28, but to the secondary transfer transport belt 40a as shown in FIG. 7 in order to transfer a patch on the secondary transfer transport belt 40a even in the present embodiment. As the density detection means 34 is arranged in opposition to the secondary transfer transport belt 40a, a usual patch can be detected, and the density of a toner image on the transfer material P can be also detected. Image control conditions with higher accuracy can be set by direct detection of a toner image.

### CROSS-REFERENCE TO RELATED APPLICATION

This application claims the benefit of priority from the prior Japanese Patent Application No. 2004-070256 filed on Mar. 12, 2004 the entire contents of which are incorporated herein by reference.

1. An image forming device comprises:
an image bearing member which bears a toner image formed of toners that have been charged to the predetermined polarity according to image information;
a transfer means by which the toner image on the image bearing member is transferred onto a transfer material by applying a bias with an opposite polarity with that of the predetermined polarity to the transfer material in a transfer area;
a first removing means which is provided outside the transfer area and removes the toners on the image bearing member; and
a second removing means which is provided outside the transfer area and removes the toners on the transfer means, wherein
the toner image in the transfer area is transferred onto the transfer means by applying a bias with an opposite polarity with that of the predetermined polarity to the transfer means when the toner image formed according to the image information is in the transfer area, and no transfer material exists in the transfer area, and, at this time,
the toner image transferred onto the transfer means is removed with the second removing means, while the toners which have not been transferred onto the transfer material and have remained on the image bearing member is removed with the first removing means.

2. The image forming device according to claim 1, wherein
the mass per unit area of the toner image which is transferred onto the transfer means is larger than that of the toners which have not been transferred onto the transfer means and have remained on the image bearing member when the toner image formed according to the image information is in the transfer area, and the transfer material does not exist in the transfer area.

3. The image forming device according to claim 2, wherein
the maximum mass per unit area of the toners which is on the transfer material and can be removed with the second removing means is larger than the maximum mass per unit area of the toners which is on the image bearing member and can be removed with the first removing means.

4. The image forming device according to claim 3, wherein
the first removing means is a brush member, and the second removing element is a blade member which is contacted with the transfer means.
